(19) United States
(12) Patent Application Publication
(10) Pub. No.: US 2012/0111911 A1
(43) Pub. Date: May 10, 2012

(54) Family Bicycle Rack for Pickup Truck

(76) Inventor: Bruce Rempe, La Porte City, IA (US)

(21) Appl. No.: 12/853,514

(22) Filed: Aug. 10, 2010

Related U.S. Application Data
(60) Provisional application No. 61/273,917, filed on Aug. 10, 2009.

(51) Int. Cl. B60R 9/00

(52) U.S. Cl. 224/403

(57) ABSTRACT

An assembly that can be installed into the bed of a pickup truck that allows for the storage of multiple bicycles in a vertical orientation. The assembly allows for the remainder of the truck bed to store supplies that storing the bicycles horizontally does not allow. The assembly can be made of various metal alloys, including stainless steel. The assembly can also be made of wood. The base of the assembly comprises two vertical members and two horizontal members with hooks and fork mounts placed at regular intervals along the horizontal members to secure the bikes in place. Two additional horizontal members that run along the length of the truck bed are used to secure the assembly in place. Two angled support braces can also be added to the assembly to provide additional support if the lengthwise members do not provide enough support.

### CROSS-REFERENCE TO RELATED APPLICATIONS

This application claims the benefit of U.S. Provisional Application No. 61/273,917 filed Aug. 10, 2009.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

Storing bicycles in the bed of a pickup truck is a simple solution for transporting bikes to an area where there are bike trails. Unfortunately, the conventional way of storing the bikes horizontally takes up all the space in the truck bed and also limits the number of bikes that can be stored. This makes it difficult to store enough bikes and supplies to go out on a family outing. The present invention addresses these problems by providing a structure that can be easily assembled in any pickup bed to store bikes vertically. This structure allows up to five bicycles to be stored and also allows for much of the pickup bed to be used for storing other items.

2. Description of Related Art

There is existing prior art that addresses storing multiple bicycles horizontally in a rack in the bed of a pickup truck. Additionally, there is existing prior art addressing the storage of bikes vertically on the back of an automobile. The prior art does not address using a bike rack for storing bikes vertically in the bed of a pickup truck.

U.S. Pat. No. 3,921,869 to Rogers discloses a device that can be attached to the back of an automobile that allows bikes to be stored vertically but the design is not made to be used in a pickup bed. U.S. Publication No. 2008/0047994 by Beamer et al. discloses a holder for storing multiple bikes horizontally in a pickup bed by using holders to hold both wheels of each bicycle in place. U.S. Pat. No. 6,179,181 to Johnson et al. discloses a rack for storing bikes horizontally in a pickup bed by securing one wheel in place using a supporter arm.

### BRIEF SUMMARY OF THE INVENTION

The present invention relates to an assembly installed into the bed of a pickup truck that allows for the storage of multiple bicycles in a vertical orientation. The assembly can be made of various metal alloys, including stainless steel. The assembly can also be made of wood. The base of the assembly comprises two vertical members and two horizontal members with hooks and fork mounts placed at regular intervals along the horizontal members to secure the bikes in place. Two additional horizontal members that run along the length of the truck bed are used to secure the assembly in place. Two angled support braces can also be added to the assembly to provide additional support if the lengthwise members do not provide enough support.

### BRIEF DESCRIPTION OF THE SEVERAL VIEWS OF THE DRAWINGS

The invention may take form in certain components and structures, preferred embodiments of which are illustrated in the accompanying drawings which form a part hereof and wherein:

FIG. 1 is a perspective view of the vertical bike storage assembly mounted into the bed of a pickup truck showing bicycles being stored.

FIG. 2 is a perspective view of the vertical bike storage assembly mounted into the bed of a pickup truck without the bicycles.

FIG. 3 is a perspective view of the vertical bike storage assembly that is not mounted into the bed of a pickup truck.

FIG. 4 is a perspective view of an alternate embodiment of the vertical bike storage assembly mounted into the bed of a pickup truck showing bicycles being stored.

### DETAILED DESCRIPTION OF THE INVENTION

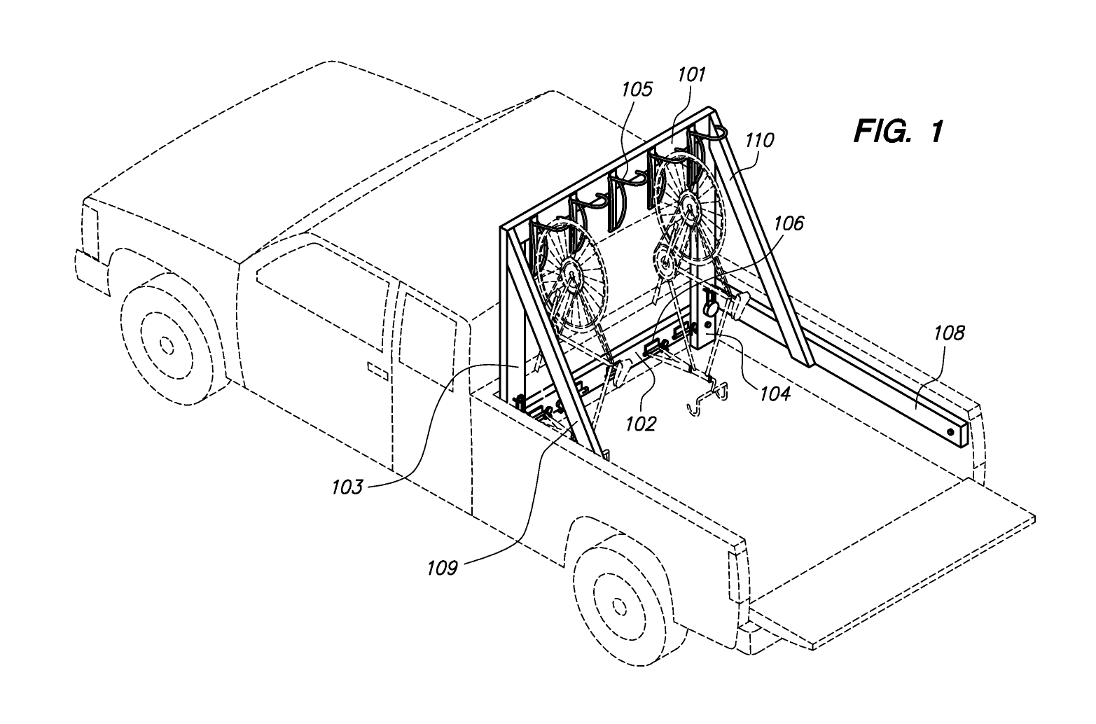

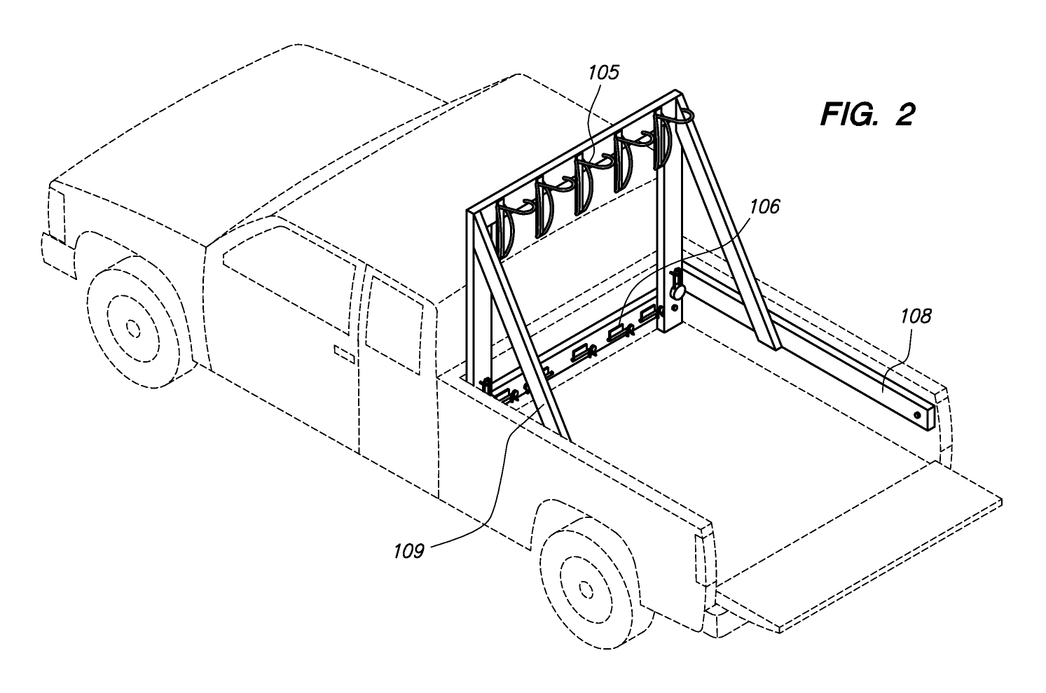

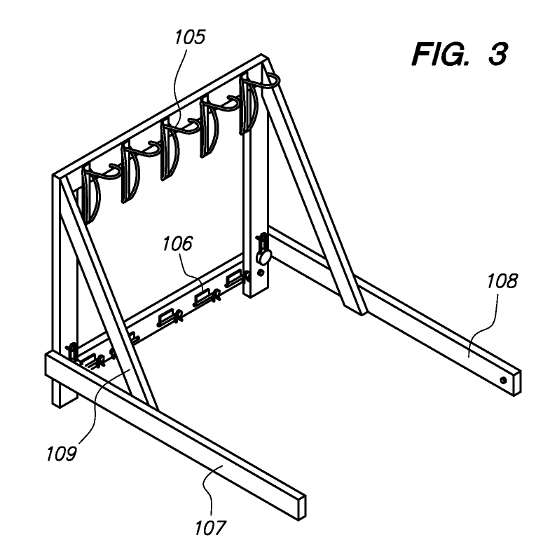

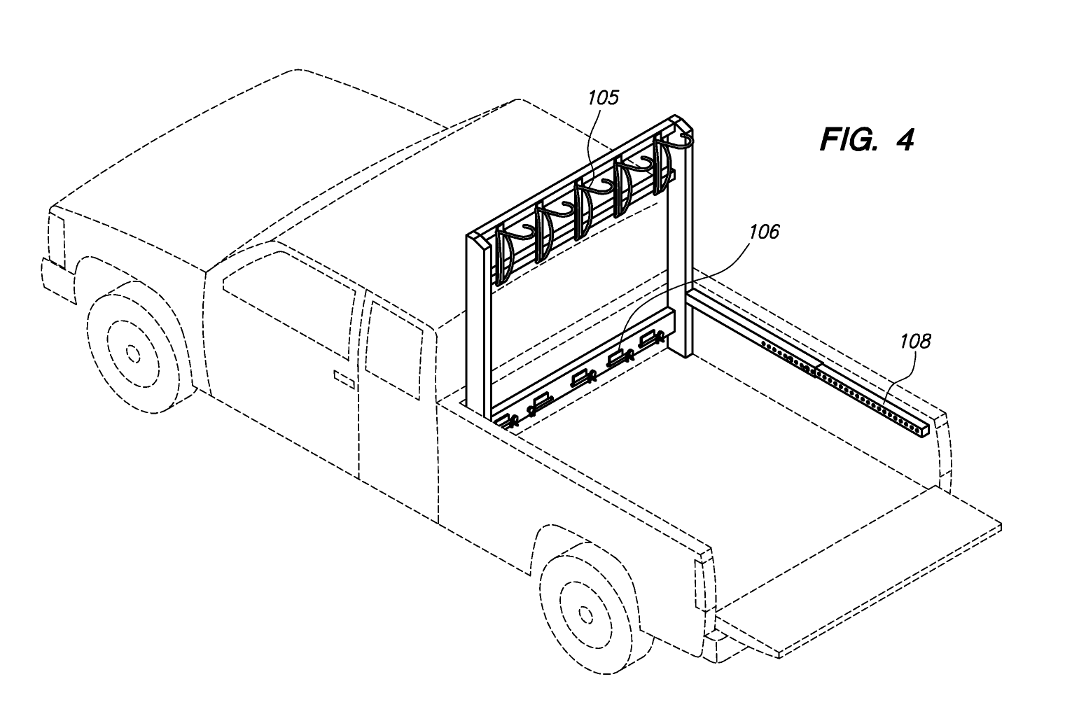

The invention is carried out as illustrated in FIGS. 1-4. An upper horizontal member 101 and a lower horizontal member 102 are connected by a first vertical member 103 and a second vertical member 104. In the preferred embodiment, the upper horizontal 101, lower horizontal 102, first 103 and second vertical members 104 are made of a metal alloy as this allows for more convenient assembly and disassembly of the rack. The metal alloy is preferably made of stainless steel, but can be made of any type of metal alloy that can quickly and conveniently be connected by a standard thread and bolt assembly. The upper 101 and lower horizontal members 102 along with the first 103 and second vertical members 104, can also be made of wood and still connected by a standard thread and bolt assembly. The upper horizontal member 101 comprises several holders 105 evenly spaced along the upper horizontal member 101 that in the preferred embodiment are a series of hooks 105 for securely holding a wheel of a bicycle in place. In other embodiments, the upper horizontal member 101 can be divided into two separate members that are separated by the length of the hooks and the holders 105 can also be a set of fork mounts 106 or a combination of both hooks 105 and fork mounts 106. The lower horizontal member 102 comprises a set of fork mounts as holders 106 that are aligned directly below the holders 105 of the upper horizontal member 101 in the preferred embodiment. In other embodiments, the holders 106 may not be aligned directly below the holders 105 of the upper horizontal member 101, but aligned a little left or right of center from the upper holders 105. The lower holders 106 can also be a combination of hooks 105 and fork mounts 106 in different embodiments as long as the holder on the upper horizontal member 101 and the corresponding holder on the lower horizontal member 102 are not both hooks 105 or fork mounts 106. To store the bicycle on the rack, one of the wheels is removed, and the hooks 105 on either the upper 101 or lower horizontal member 102 are run through the spokes of the remaining wheel. The release point of the wheel that has been removed from the bicycle will be inserted into the fork mount 106 on the either upper 101 or lower horizontal member 102 to make sure that the bicycle is securely connected to the rack in two places.

The rack is connected to the truck bed by connecting one end of a first 107 and second support rail 108 to the first 103 and second vertical support members 104 by a standard thread and bolt assembly. In the preferred embodiment, the first 107 and second support rail 108 are made of stainless steel. The use of stainless steel for the rack and support rails should provide for a very solid, stable structure. However, any metal alloy can be used. Additionally, similar to the rest of the rack, the first 107 and second support rail 108 can also be made of wood and still connected with a standard thread and bolt assembly. The second end of the first 107 and second support rails 108 are connected to the truck bed by using a right angle bracket that can be attached to the truck and then using a thread and bolt assembly to connect the rail to the bracket and therefore the truck.

If the first 107 and second support rail 108 are not enough to support the weight of rack, an additional first 109 and second support brace 110 can be added to the structure. The first 109 and second support braces 110 would be connected on one end to the upper horizontal member 101 and angled downwards to connect the second end to the first 107 and second support rails 108. In the preferred embodiment, this angle would be 45 degrees as that would provide the optimum amount of stability to the structure. The first 109 and second support braces 110 can be connected by the same thread and bolt assembly to both the upper horizontal member 101 and the first 107 and second support rails 108.

What is claimed is:

1. A storing assembly for storing bikes vertically on a truck bed, comprising:
a first vertical support member and a second vertical support member made of a sturdy, rigid material and of a sufficient length to hang a bicycle vertically with a first wheel of said bicycle removed and not allowing a second wheel remaining attached to said bicycle to touch a bed of a pickup truck when said first vertical support member and said second vertical support member are standing upright;
with said first vertical support member and said second vertical support member having a top end, a bottom end, a front side, a back side, an inner side, an outer side, a top half and a bottom half and said back side of said first vertical support member and said second vertical support member facing a cab of said pickup truck;
wherein said inner side of said first vertical support member is facing said inner side of said second vertical support member;
an upper horizontal member made of same said sturdy rigid material of said first and second vertical member with a first end, a second end, a front side and a back side;
a lower horizontal member made of same said sturdy rigid material of said first and second vertical member with a first end, a second end, a front side and a back side;
wherein said first end of said upper horizontal member is securely connected to said top end of said first vertical support member and said second end of said upper horizontal member is securely connected to said top end of said second vertical support member;
wherein said first end of said lower horizontal member is securely connected to said inner side of said bottom half of said first vertical support member and said second end of said lower horizontal member is securely connected to said inner side of said bottom half of said second vertical support member;
wherein said bottom end of said first vertical support member rests on said truck bed;
wherein said bottom end of said second vertical support member rests on said truck bed;
wherein said front side of said upper horizontal member includes a plurality of holders securely connected and evenly spaced apart along the length of said upper horizontal member and said back side of said upper horizontal member is facing said cab of said pickup truck;
wherein said front side of said lower horizontal member includes a plurality of holders securely connected and evenly spaced along the length of said lower horizontal member and aligned below said plurality of holders on said upper horizontal member in such a position that allows said bike to be stored securely and said back side of said lower horizontal member is facing said cab of said pickup truck;
a first support rail and a second support rail with a front side, a back side, a first side end and a second side end made of the same said sturdy rigid material of said first and second vertical member;
wherein said front side of said first support rail is facing said front side of said second support rail;
wherein said first side end of said first support rail is securely connected to said front side of said first vertical support member;
wherein said first side end of said second support rail is securely connected to said front said of said second vertical support member;
wherein said back side of said second side end of said first support rail is securely connected to a first end of said pickup truck;
wherein said back side of said second side end of said second support rail is securely connected to a second end of said pickup truck.

2. The storing assembly of claim 1, wherein said sturdy, rigid material of said first vertical support member, said second vertical support member, said upper horizontal member, said lower horizontal member, said first support rail and said second support rail are made of a metal alloy.

3. The storing assembly of claim 3, wherein said metal alloy is stainless steel.

4. The storing assembly of claim 1, wherein said sturdy, rigid material of said first vertical support member, said second vertical support member, said first upper horizontal member, said lower horizontal member, said first support rail and said second support rail are made of wood.

5. The storing assembly of claim 2, wherein said upper horizontal member is securely connected to said first vertical support member and said second vertical support member by a standard thread and bolt assembly;
said lower horizontal member is securely connected to said first vertical support member and said second vertical support member by a standard thread and bolt assembly;
said first support rail is securely connected to said first vertical support member using a standard thread and bolt assembly;
said second support rail is securely connected to said second vertical support member using a standard thread and bolt assembly;
said back side of said second side end of said first support rail is connected to said truck by running a standard thread and bolt assembly through a right angle bracket that attaches to a first post pocket located near said first end of said pickup truck;
said back side of said second side end of said second support rail is connected to said truck by running a standard thread and bolt assembly through a right angle bracket that attaches to a second post pocket located near said second end of said pickup truck.

6. The storing assembly of claim 3, wherein said upper horizontal member is securely connected to said first vertical support member and said second vertical support member by a standard thread and bolt assembly;
said lower horizontal member is securely connected to said first vertical support member and said second vertical support member by a standard thread and bolt assembly;
said first support rail is securely connected to said first vertical support member using a standard thread and bolt assembly;
said second support rail is securely connected to said second vertical support member using a standard thread and bolt assembly;
said back side of said second side end of said first support rail is connected to said truck by running a standard thread and bolt assembly through a right angle bracket that attaches to a first post pocket located near said first end of said pickup truck;
said back side of said second side end of said second support rail is connected to said truck by running a standard thread and bolt assembly through a right angle bracket that attaches to a second post pocket located near said second end of said pickup truck.

7. The storing assembly of claim 4, wherein said upper horizontal member is securely connected to said first vertical support member and said second vertical support member by a standard thread and bolt assembly;
said lower horizontal member is securely connected to said first vertical support member and said second vertical support member by a standard thread and bolt assembly;
said first support rail is securely connected to said first vertical support member using a standard thread and bolt assembly;
said second support rail is securely connected to said second vertical support member using a standard thread and bolt assembly;
said back side of said second side end of said first support rail is connected to said truck by running a standard thread and bolt assembly through a right angle bracket that attaches to a first post pocket located near said first end of said pickup truck;
said back side of said second side end of said second support rail is connected to said truck by running a standard thread and bolt assembly through a right angle bracket that attaches to a second post pocket located near said second end of said pickup truck.

8. The storing assembly of claim 2, wherein said plurality of holders on said upper horizontal member are either a set of hooks or a set of fork mounts or a combination of both.

9. The storing assembly of claim 8, wherein said plurality of holders on said lower horizontal member are a set of hooks or a set of fork mounts or a combination of both, so long as said holder on said upper horizontal member and said holder on said lower horizontal member are not both hooks or fork mounts.

10. The storing assembly of claim 2, wherein said upper horizontal member is divided into a first and second upper horizontal member;
wherein said first upper horizontal member is securely connected to the top of said hook and said second upper horizontal member is securely connected to the bottom of said hook and there is a space between said first upper horizontal member and said second horizontal member and said first and second upper horizontal members are securely connected to said first and second vertical support members.

11. A storing assembly for storing bicycles vertically on a truck bed, comprising:
a first vertical support member and a second vertical support member made of a sturdy, rigid material and of a sufficient length to hang a bicycle vertically with a first wheel removed and not allowing a second wheel remaining attached to said bicycle to touch a bed of a pickup truck when said first and second vertical support members are standing upright;
with said first vertical support member and said second vertical support member having a top end, a bottom end, a front side, a back side, an inner side, an outer side, a top half and a bottom half and said back side of said first vertical support member and said second vertical support member facing a cab of said pickup truck;
wherein said inner side of said first vertical support member is facing said inner side of said second vertical support member;
an upper horizontal member made of the same said sturdy rigid material of said first and second vertical member with a first end, a second end, a front side and a back side;
a lower horizontal member made of the same said sturdy rigid material of said first and second vertical member with a first end, a second end, a front side and a back side;
wherein said first end of said upper horizontal member is securely connected to said top end of said first vertical support member and said second end of said upper horizontal member is securely connected to said top end of said second vertical support member;
wherein said first end of said lower horizontal member is securely connected to said inner side of said bottom half of said first vertical support member and said second end of said lower horizontal member is securely connected to said inner side of said bottom half of said second vertical support member;
wherein said bottom end of said first vertical support member rests on said truck bed;
wherein said bottom end of said second vertical support member rests on said truck bed;
wherein said front side of said upper horizontal member includes a plurality of holders evenly spaced apart along the length of said upper horizontal member and said back side of said upper horizontal member is facing said cab of said pickup truck;
wherein said plurality of holders of said upper horizontal member is capable of holding a set of hooks or a set of fork mounts or a combination of both;
wherein said front side of said lower horizontal member includes a plurality of holders evenly spaced along the length of said lower horizontal member and aligned below said plurality of holders on said upper horizontal member in such a position that allows said bike to be stored securely and said back side of said lower horizontal member is facing said cab of said pickup truck;
wherein said plurality of holders of said lower horizontal member is capable of holding a set of hooks or a set of fork mounts so long as said holder on said upper horizontal member and said holder on said lower horizontal member are not both hooks or fork mounts;
a first support brace and a second support brace made of the same said sturdy rigid material of said first and second vertical member with a front side, a back side, a first side end and a second side end;
a first and second support rail made of the same said sturdy rigid material of said first and second vertical member with a front side, a back side, a first side end and a second side end;
wherein said first side end of said first support brace is securely connected to said first end of said front side of said upper horizontal member at a sufficient angle that provides additional stability;
wherein said first side end of said second support brace is securely connected to said second end of said front side of said upper horizontal member at a sufficient angle that provides additional stability;
wherein said second side end of said first support brace is securely connected to said front side of said first support rail at a sufficient angle that provides additional stability;
wherein said second side end of said second support brace is securely connected to said front side of said second support rail at a sufficient angle that provides additional stability;
a first support rail and a second support rail with a front side, a back side, a first side end and a second side end made of the same said sturdy rigid material of said first and second vertical member;
wherein said front side of said first support rail is facing said front side of said second support rail;
wherein said front side of said first support rail is facing said front side of said second support rail;
wherein said first side end of said first support rail is securely connected to said front side of said first vertical support member;
wherein said first side end of said second support rail is securely connected to said front said of said second vertical support member;
wherein said back side of said second side end of said first support rail is securely connected to a first end of said pickup truck;
wherein said back side of said second side end of said second support rail is securely connected to a second end of said pickup truck.

12. The storing assembly of claim 11, wherein said sturdy, rigid material of said first vertical support member, said second vertical support member, said upper horizontal member, said lower horizontal member, said first support brace, said second support brace, said first support rail and said second support rail are made of a metal alloy.

13. The storing assembly of claim 13, wherein said metal alloy is stainless steel.

14. The storing assembly of claim 11, wherein said sturdy, rigid material of said first vertical support member, said second vertical support member, said upper horizontal member, said lower horizontal member, said first support brace, said second support brace, said first support rail and said second support rail are made of wood.

15. The storing assembly of claim 12, wherein said upper horizontal member is securely connected to said first vertical support member and said second vertical support member by a standard thread and bolt assembly;
said lower horizontal member is securely connected to said first vertical support member and said second vertical support member by a standard thread and bolt assembly;
said first support rail is securely connected to said first vertical support member using a standard thread and bolt assembly;
said second support rail is securely connected to said second vertical support member using a standard thread and bolt assembly;
wherein said first side end of said first support brace is securely connected to said first end of said front side of said upper horizontal member at a 45 degree angle using a standard thread and bolt assembly;
wherein said first side end of said second support brace is securely connected to said second end of said front side of said upper horizontal member at a 45 degree angle using a standard thread and bolt assembly;
wherein said second side end of said first support brace is securely connected at a 45 degree angle to said front side of said first support rail using a standard thread and bolt assembly;
wherein said second side end of said second support brace is securely connected at a 45 degree angle to said front side of said second support rail using a standard thread and bolt assembly;
said back side of said second side end of said first support rail is connected to said truck by running a standard thread and bolt assembly through a right angle bracket that attaches to a first post pocket located near said first end of said pickup truck;
said back side of said second side end of said second support rail is connected to said truck by running a standard thread and bolt assembly through a right angle bracket that attaches to a second post pocket located near said second end of said pickup truck.

16. The storing assembly of claim 13, wherein said upper horizontal member is securely connected to said first vertical support member and said second vertical support member by a standard thread and bolt assembly;
said lower horizontal member is securely connected to said first vertical support member and said second vertical support member by a standard thread and bolt assembly;
said first support rail is securely connected to said first vertical support member using a standard thread and bolt assembly;
said second support rail is securely connected to said second vertical support member using a standard thread and bolt assembly;
wherein said first side end of said first support brace is securely connected to said first end of said front side of said upper horizontal member at a 45 degree angle using a standard thread and bolt assembly;
wherein said first side end of said second support brace is securely connected to said second end of said front side of said upper horizontal member at a 45 degree angle using a standard thread and bolt assembly;
wherein said second side end of said first support brace is securely connected at a 45 degree angle to said front side of said first support rail using a standard thread and bolt assembly;
wherein said second side end of said second support brace is securely connected at a 45 degree angle to said front side of said second support rail using a standard thread and bolt assembly;
said back side of said second side end of said first support rail is connected to said truck by running a standard thread and bolt assembly through a right angle bracket that attaches to a first post pocket located near said first end of said pickup truck;
said back side of said second side end of said second support rail is connected to said truck by running a standard thread and bolt assembly through a right angle bracket that attaches to a second post pocket located near said second end of said pickup truck.

17. The storing assembly of claim 14, wherein said upper horizontal member is securely connected to said first vertical support member and said second vertical support member by a standard thread and bolt assembly;
said lower horizontal member is securely connected to said first vertical support member and said second vertical support member by a standard thread and bolt assembly;
said first support rail is securely connected to said first vertical support member using a standard thread and bolt assembly;
said second support rail is securely connected to said second vertical support member using a standard thread and bolt assembly;
wherein said first side end of said first support brace is securely connected to said first end of said front side of said upper horizontal member at a 45 degree angle using a standard thread and bolt assembly;
wherein said first side end of said second support brace is securely connected to said second end of said front side of said upper horizontal member at a 45 degree angle using a standard thread and bolt assembly;
wherein said second side end of said first support brace is securely connected at a 45 degree angle to said front side of said first support rail using a standard thread and bolt assembly;
wherein said second side end of said second support brace is securely connected at a 45 degree angle to said front side of said second support rail using a standard thread and bolt assembly;
said back side of said second side end of said first support rail is connected to said truck by running a standard thread and bolt assembly through a right angle bracket that attaches to a first post pocket located near said first end of said pickup truck;
said back side of said second side end of said second support rail is connected to said truck by running a standard thread and bolt assembly through a right angle bracket that attaches to a second post pocket located near said second end of said pickup truck.

18. A method for securing a set of bicycles to a vertical storing assembly on a truck bed, comprising:
a first vertical support member and a second vertical support member made of a sturdy, rigid material and of a sufficient length to hang a bicycle vertically with a first wheel removed and not allowing a second wheel remaining attached to said bicycle to touch a bed of a pickup truck when said first and second vertical support members are standing upright;
with said first vertical support member and said second vertical support member having a top end, a bottom end, a front side, a back side, an inner side, an outer side, a top half and a bottom half and said back side of said first vertical support member and said second vertical support member facing a cab of said pickup truck;
wherein said inner side of said first vertical support member is facing said inner side of said second vertical support member;
an upper horizontal member made of same said sturdy rigid material of said first and second vertical member with a first end, a second end, a front side and a back side;
a lower horizontal member made of same said sturdy rigid material of said first and second vertical member with a first end, a second end, a front side and a back side;
wherein said first end of said upper horizontal member is securely connected to said top end of said first vertical support member and said second end of said upper horizontal member is securely connected to said top end of said second vertical support member;
wherein said first end of said lower horizontal member is securely connected to said inner side of said bottom half of said first vertical support member and said second end of said lower horizontal member is securely connected to said inner side of said bottom half of said second vertical support member;
wherein said bottom end of said first vertical support member rests on said truck bed;
wherein said bottom end of said second vertical support member rests on said truck bed;
wherein said front side of said upper horizontal member includes a plurality of holders securely connected and evenly spaced apart along the length of said upper horizontal member and said back side of said upper horizontal member is facing said cab of said pickup truck;
wherein said front side of said lower horizontal member includes a plurality of holders securely connected and evenly spaced along the length of said lower horizontal member and aligned below said plurality of holders on said upper horizontal member in such a position that allows said bike to be stored securely and said back side of said lower horizontal member is facing said cab of said pickup truck;
a first support rail and a second support rail with a front side, a back side, a first side end and a second side end made of the same said sturdy rigid material of said first and second vertical member;
wherein said front side of said first support rail is facing said front side of said second support rail;
wherein said first side end of said first support rail is securely connected to said front side of said first vertical support member;
wherein said first side end of said second support rail is securely connected to said front said of said second vertical support member;
wherein said back side of said second side end of said first support rail is securely connected to a first end of said pickup truck;
wherein said back side of said second side end of said second support rail is securely connected to a second end of said pickup truck;
securing a location where said first wheel attaches to said bicycle onto one of said plurality of holders on said lower horizontal member and securing said second wheel of said bicycle onto one of said plurality of holders on said upper horizontal member.

19. The method for securing a set of bicycles to a vertical storing assembly on a truck bed of claim 18, further comprising:
said plurality of holders of said upper horizontal member is a set of hooks and said plurality of holders of lower horizontal member is a set of fork mounts;
securing said location where said first wheel attaches to said bicycle to a fork mount out of said set of fork mounts;
wherein said second wheel of said bicycle is attached to a hook out of said set of hooks.

20. The method for securing a set of bicycles to a vertical storing assembly on a truck bed of claim 18, further comprising:
said plurality of holders of said lower horizontal member is a set of hooks and said plurality of holders of upper horizontal member is a set of fork mounts;
securing said location where said first wheel attaches to said bicycle to a fork mount out of said set of fork mounts;
wherein said second wheel of said bicycle is attached to a hook out of said set of hooks.
